(19) United States
(12) Patent Application Publication
(10) Pub. No.: US 2022/0031052 A1
(43) Pub. Date: Feb. 3, 2022

(54) Phone Tethering Device

(71) Applicant: James Parker, La Grange, TX (US)

(72) Inventor: James Parker, La Grange, TX (US)

(21) Appl. No.: 17/343,395

(22) Filed: Jun. 9, 2021

Related U.S. Application Data
(60) Provisional application No. 63/058,573, filed on Jul. 30, 2020.

(51) Int. Cl. A45F 5/02; H04M 1/04

(52) U.S. Cl. CPC A45F 5/02; A45F 2005/006; H04M 1/04

(57) ABSTRACT

A phone tethering device for tethering a phone to a user to deter droppage and loss of the phone includes a first fastener, which is engaged to a phone case, and second fastener, which is engaged to a tether. The second fastener is complementary to the first fastener and thus is positioned to selectively engage the first fastener to removably engage the tether to the phone case. A connector, which is engaged to the tether distal from the second fastener, can engage the tether to a user, an article engaged to the user, or an item in possession of the user, to tether the phone case and a phone positioned in the phone case to the user, the article, or the item. The tether deters droppage and loss of the phone case and a phone positioned in the phone case. The tether also facilitates carrying of the phone without use of a pocket.

### (b) CROSS-REFERENCE TO RELATED APPLICATIONS

I hereby claim the benefit under 35 U.S.C. Section 119(e) of U.S. Provisional application 63/058,573 filed on Jul. 30, 2020.

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to tethering devices and more particularly pertains to a new tethering device for tethering a phone to a user to deter droppage and loss of the phone. The present invention discloses a tethering device comprising first and second fasteners, which are engageable to a phone case and a tether, respectively, so that the tether can be removably engaged to the phone case. The tether is fitted distally with a connector, such as a clip or lanyard, for tethering the phone case and a phone to a user, an article engaged to the user, or an item in possession of the user.

### (2) Description of Related Art Including Information Disclosed Under 37 CFR 1.97 and 1.98

The prior art relates to tethering devices for phones. Prior art tethering devices may comprise retractable leashes, chains, or lanyards. What is lacking in the prior art is a tethering device comprising first and second fasteners, which are engageable to a phone case and a tether, respectively, so that the tether can be removably engaged to the phone case. The tether is fitted distally with a connector, such as a clip or lanyard, for tethering the phone case and a phone to a user, an article engaged to the user, or an item in possession of the user.

### (h) BRIEF SUMMARY OF THE INVENTION

An embodiment of the disclosure meets the needs presented above by generally comprising a first fastener, which is engaged to a phone case, and second fastener, which is engaged to a tether. The second fastener is complementary to the first fastener and thus is positioned to selectively engage the first fastener to removably engage the tether to the phone case.

A connector is engaged to the tether distal from the second fastener. The connector is configured to engage the tether to a user, an article engaged to the user, or an item in possession of the user, to tether the phone case to the user, the article, or the item. The tether is configured to deter droppage and loss of the phone case and a phone positioned in the phone case. The tether also is configured to facilitate carrying of the phone without use of a pocket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a phone tethering device according to an embodiment of the disclosure.

FIG. 2 is a front view of an embodiment of the disclosure.

FIG. 3 is a front view of an embodiment of the disclosure.

### (j) DETAILED DESCRIPTION OF THE INVENTION

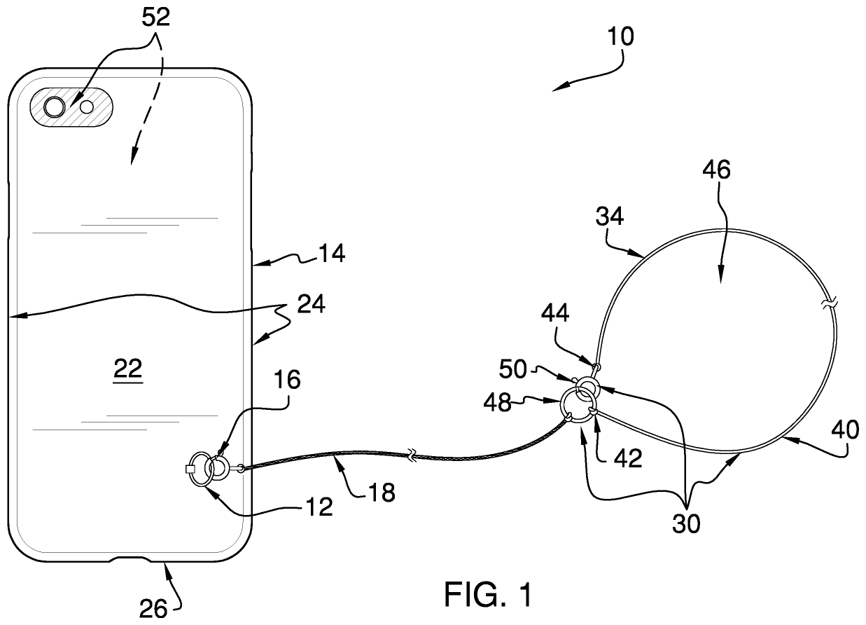

With reference now to the drawings, and in particular to FIGS. 1 through 3 thereof, a new tethering device embodying the principles and concepts of an embodiment of the disclosure and generally designated by the reference numeral 10 will be described.

As best illustrated in FIGS. 1 through 3, the phone tethering device 10 generally comprises a first fastener 12, which is engaged to a phone case 14, and a second fastener 16, which is engaged to a tether 18. The second fastener 16 is complementary to the first fastener 12 and thus is positioned to selectively engage the first fastener 12 to removably engage the tether 18 to the phone case 14.

The first fastener 12 comprises a ringlet 20. The ringlet 20 may be hingedly engaged to the phone case 14 so that the ringlet 20 can be selectively positioned in a deployed configuration and a stowed configuration. In the deployed configuration, the ringlet 20 extends from the phone case 14. In the stowed configuration, the ringlet 20 is positioned in abutment to the phone case 14.

The first fastener 12 is engaged to a rear face 22 of the phone case 14. The first fastener 12 may be engaged to the phone case 14 proximate to a respective opposed side 24 thereof. The first fastener 12 may be engaged to the phone case 14 proximate to a bottom 26 thereof.

The second fastener 16 comprises a fastening ring clasp 28. The present invention anticipates the second fastener 16 and the first fastener 12 comprising other fastening pairs, such as, but not limited to, hook and eye fasteners, hook and loop fasteners, snap fasteners, and the like.

The tether 18 comprises rope, chain, cable, cord, string, wire, line, or the like. The tether 18 may comprise gold chain or silver chain. The tether 18 measures from 15.0 to 120.0 centimeters in length. The tether 18 may measure from 30.0 to 90.0 centimeters in length.

A connector 30 is engaged to the tether 18 distal from the second fastener 16. The connector 30 is configured to engage the tether 18 to a user, an article engaged to the user, or an item in possession of the user, to tether the phone case 14 to the user, the article, or the item. The tether 18 is configured to deter droppage and loss of the phone case 14 and a phone 52 positioned in the phone case 14. The tether 18 also is configured to facilitate carrying of the phone 52 without use of a pocket.

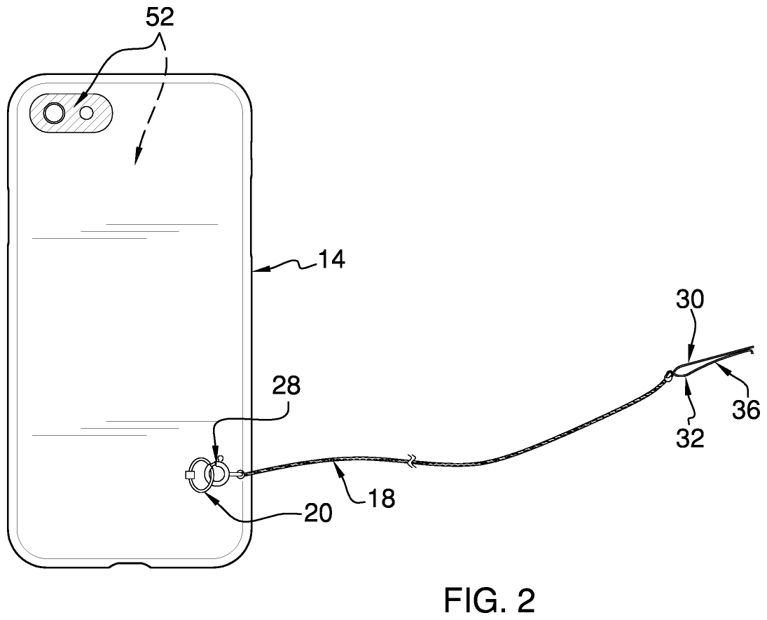

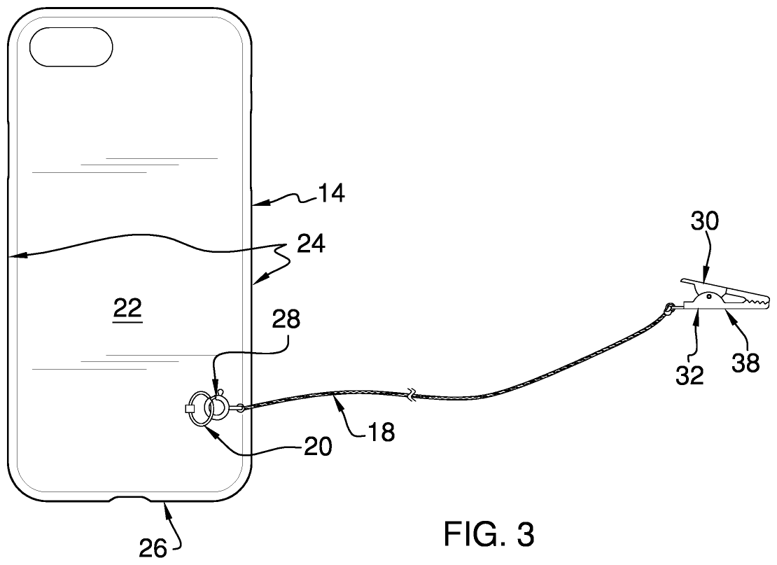

The connector 30 comprises a clip 32, as shown in FIGS. 2 and 3, a lanyard 34, as shown in FIG. 1, or other connecting means, such as, but not limited to, elastomeric loops, hooks, and the like. The clip 32 is configured to be clipped to the article that is engaged to the user, such as an article of clothing, or the item that is in the possession of the user, such as a purse, to tether the phone case 14 and the phone 52 to the article or to the item. The clip 32 comprises a tie clip 36 or an alligator clip 38.

The lanyard 34 is configured to be positioned around a wrist or a neck of the user to tether the phone case 14 to the user. The lanyard 34 comprises a line 40, which has a first end 42 and a second end 44 coupled to the tether 18 to define a loop 46. The loop 46 is configured for insertion of the wrist or the neck of the user to tether the phone case 14 and the phone 52 to the user.

A ring 48 is engaged to and positioned between the tether 18 and the first end 42 of the line 40. A securing ring clasp 50 is engaged to the second end 44 of the line 40. The securing ring clasp 50 is selectively engageable to the ring so that the ring and the securing ring clasp 50 are interlocked. The line 40 is configured to be looped around the wrist or the neck of the user, positioning the securing ring clasp 50 to engage the ring so that the phone case 14 and the phone 52 tethered to the user.

In use, the fastening ring clasp 28 is engaged to the ringlet 20 to engage the tether 18 to the phone case 14. The clip 32 is clipped to the article that is engaged to the user, such as the article of clothing, or the item that is in the possession of the user, such as the purse, to tether the phone case 14 and the phone 52 to the article or the item.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A phone tethering device comprising:
a first fastener engaged to a phone case;
a second fastener engaged to a tether, the second fastener being complementary to the first fastener, such that the second fastener is positioned for selectively engaging the first fastener for removably engaging the tether to the phone case; and
a connector engaged to the tether distal from the second fastener, the connector being configured for engaging the tether to a user, an article engaged to the user, or an item in possession of the user, for tethering the phone case and a phone positioned in the phone case to the user, the article, or the item, wherein the tether is configured for deterring droppage and loss of the phone case and the phone, and wherein the tether is configured for facilitating carrying of the phone without use of a pocket.

2. The phone tethering device of claim 1, wherein:
the first fastener comprises a ringlet;
the second fastener comprises a fastening ring clasp; and
the tether comprises rope, chain, cable, cord, string, wire, or line.

3. The phone tethering device of claim 2, wherein the ringlet is hingedly engaged to the phone case, such that the ringlet can be selectively positioned in a deployed configuration, wherein the ringlet extends from the phone case, and a stowed configuration, wherein the ringlet is positioned in abutment to the phone case.

4. The phone tethering device of claim 2, wherein the first fastener is engaged to a rear face of the phone case.

5. The phone tethering device of claim 2, wherein the first fastener is engaged to the phone case proximate to a respective opposed side of the phone case.

6. The phone tethering device of claim 2, wherein the first fastener is engaged to the phone case proximate to a bottom of the phone case.

7. The phone tethering device of claim 2, wherein the tether comprises gold chain or silver chain.

8. The phone tethering device of claim 2, wherein the tether measures from 15.0 to 120.0 centimeters in length.

9. The phone tethering device of claim 8, wherein the tether measures from 30.0 to 90.0 centimeters in length;

10. The phone tethering device of claim 2, wherein the connector comprises a clip or a lanyard, wherein the clip is configured for clipping to the or the item for tethering the phone case and the phone to the article or the item, wherein the lanyard is configured for positioning around a wrist or a neck of the user for tethering the phone case and the phone to the user.

11. The phone tethering device of claim 10, wherein the clip comprises a tie clip or an alligator clip.

12. The phone tethering device of claim 10, wherein the lanyard comprises a line having a first end and a second end coupled to the tether defining a loop, wherein the loop is configured for inserting the wrist or the neck of the user for tethering the phone case and the phone to the user.

13. The phone tethering device of claim 12, further including:
a ring engaged to and positioned between the tether and the first end of the line; and
a securing ring clasp engaged to the second end of the line, the securing ring clasp being selectively engageable to the ring, such that the ring and the securing ring clasp are interlocked, wherein the line is configured for looping around the wrist or the neck of the user, positioning the securing ring clasp for engaging the ring, such that the phone case and the phone are tethered to the user.

14. A phone tethering system comprising:
a phone;
a phone case positioned on the phone;
a first fastener engaged to the phone case;
a second fastener engaged to a tether, the second fastener being complementary to the first fastener, such that the second fastener is positioned for selectively engaging the first fastener for removably engaging the tether to the phone case; and
a connector engaged to the tether distal from the second fastener, the connector being configured for engaging the tether to a user, an article engaged to the user, or an item in possession of the user, for tethering the phone case and the phone to the user, the article, or the item, wherein the tether is configured for deterring droppage and loss of the phone case and the phone, and wherein the tether is configured for facilitating carrying of the phone without use of a pocket.

15. A phone tethering device comprising:
a first fastener engaged to a phone case, the first fastener comprising a ringlet, the first fastener being engaged to a rear face of the phone case, the first fastener being engaged to the phone case proximate to a respective opposed side of the phone case, the first fastener being engaged to the phone case proximate to a bottom of the phone case;
a second fastener engaged to a tether, the second fastener being complementary to the first fastener, such that the second fastener is positioned for selectively engaging the first fastener for removably engaging the tether to the phone case, the second fastener comprising a fastening ring clasp, the tether comprising rope, chain, cable, cord, string, wire, or line, the tether comprising gold chain or silver chain, the tether measuring from 15.0 to 120.0 centimeters in length, the tether measuring from 30.0 to 90.0 centimeters in length;
a connector engaged to the tether distal from the second fastener, the connector being configured for engaging the tether to a user, an article engaged to the user, or an item in possession of the user, for tethering the phone case and a phone positioned in the phone case to the user, the article, or the item, wherein the tether is configured for deterring droppage and loss of the phone case and the phone, and wherein the tether is configured for facilitating carrying of the phone without use of a pocket, the connector comprising a clip or a lanyard, wherein the clip is configured for clipping to the article or the item for tethering the phone case and the phone to the article or the item, wherein the lanyard is configured for positioning around a wrist or a neck of the user for tethering the phone case and the phone to the user, the clip comprising a tie clip or an alligator clip, the lanyard comprising a line having a first end and a second end coupled to the tether defining a loop, wherein the loop is configured for inserting the wrist or the neck of the user for tethering the phone case and the phone to the user;
a ring engaged to and positioned between the tether and the first end of the line; and
a securing ring clasp engaged to the second end of the line, the securing ring clasp being selectively engageable to the second ring, such that the second ring and the first ring are interlocked, wherein the line is configured for looping around the wrist or the neck of the user, positioning the securing ring clasp for engaging the ring, such that the phone case and the phone are tethered to the user.
